(19) United States
(12) Patent Application Publication
(10) Pub. No.: US 2019/0240963 A1
(43) Pub. Date: Aug. 8, 2019

(54) WATERPROOF DECORATIVE STRIP

(71) Applicant: MING-JE TSAI, Changhua County (TW)

(72) Inventor: MING-JE TSAI, Changhua County (TW)

(21) Appl. No.: 15/886,952

(22) Filed: Feb. 2, 2018

(51) Int. Cl. B32B 27/40; B32B 37/06; B32B 37/10

(52) U.S. Cl. CPC B32B 27/40; B32B 37/06; B32B 2307/73; B32B 2451/00; B32B 37/10

(57) ABSTRACT

A waterproof decorative strip includes a strip body, having at least one decorative surface; a film layer, assembled on the decorative surface of the strip body; and a TPU waterproof layer, disposed on an outer side of the film layer for covering the film layer and the strip body to become a whole. The strip body is covered with the TPU waterproof layer, enabling the whole decorative strip to be water-resistant and durable. The decorative strip may be used for decorating the appearance of accessories or providing the functionality of accessories. The service life can be prolonged greatly.

### FIELD OF THE INVENTION

The present invention relates to a waterproof decorative strip, and more particularly to a decorative strip that has good water resistance such that the strip covered with a TPU waterproof layer won't be wet.

### BACKGROUND OF THE INVENTION

In order to increase the aesthetics and functionality of apparel accessories, the apparel accessories are always provided with decorative strips. For example, the vamp of a shoe is provided with decorative strips on two sides thereof. The decorative strip may be applied to the handle of a bag or a backpack strap. The aforementioned decorative strip can increase the variety of accessories to beautify and decorate accessories.

The aforementioned decorative strip may be made of leather, synthetic leather, webbing and other structures, but the disadvantage is that the decorative strip is not water-resistant. For example, the decorative strip made of leather or synthetic leather becomes aged and cracked easily when wetted with water, resulting in poor appearance of the decorative strip and a loss of functionality of the decorative strip. In the case of webbing, it is prone to off-line, color fading and so on.

The variety of the conventional decorative strip is less, and the appearance is more monotonous. Accordingly, the inventor of the present invention has devoted himself based on his many years of practical experiences to solve these problems.

### SUMMARY OF THE INVENTION

The primary object of the present invention is to provide a waterproof decorative strip. A strip body is covered with a film layer. The film layer is covered with a TPU waterproof layer. Thereby, the decorative strip has good waterproofness and can prolong its service life.

Another object of the present invention is to provide a waterproof decorative strip. The film layer may be made of different materials. When the strip body is covered with the TPU waterproof layer, the integrated decorative strip has a different appearance to attract more people to buy the products.

In order to achieve the aforesaid objects, the waterproof decorative strip of the present invention comprises a strip body, having at least one decorative surface; a film layer, assembled on the decorative surface of the strip body; and a TPU waterproof layer, disposed on an outer side of the film layer for covering the film layer and the strip body to become a whole.

Through the above structure, the present invention has the following advantages:

1. The TPU material is a new generation of engineering plastics, and belongs to an economical recyclable environment-friendly plastic elastomer, and has excellent wear resistance and tear resistance, anti-hydrolysis and antibacterial effect, excellent cold resistance and bending resistance, fire resistance and oil resistance, which is a green plastic material. The TPU material may be used for special rubber coating, so that different materials may be covered with the TPU material.

2. After the strip body is covered with the film layer (one-sided or double-sided), the TPU waterproof layer is to cover the strip body and the film layer, enabling the whole decorative strip to be water-resistant and durable. The decorative strip may be used for decorating the appearance of accessories or providing the functionality of accessories. The service life can be prolonged greatly.

3. The film layer may be made of different types and materials for the decorative strip to generate luminous, change color, reduce impact and crack, or isolate ultraviolet ray, thereby improving the appearance and function of the present invention.

### BRIEF DESCRIPTION OF THE DRAWINGS

FIG. 1 is an exploded view of the present invention;

FIG. 2 is a perspective view of the present invention;

FIG. 3 is a sectional view of the present invention;

FIG. 4 is a first schematic view of the present invention when in use; and

FIG. 5 is a second schematic view of the present invention when in use.

### DETAILED DESCRIPTION OF THE PREFERRED EMBODIMENTS

Embodiments of the present invention will now be described, by way of example only, with reference to the accompanying drawings.

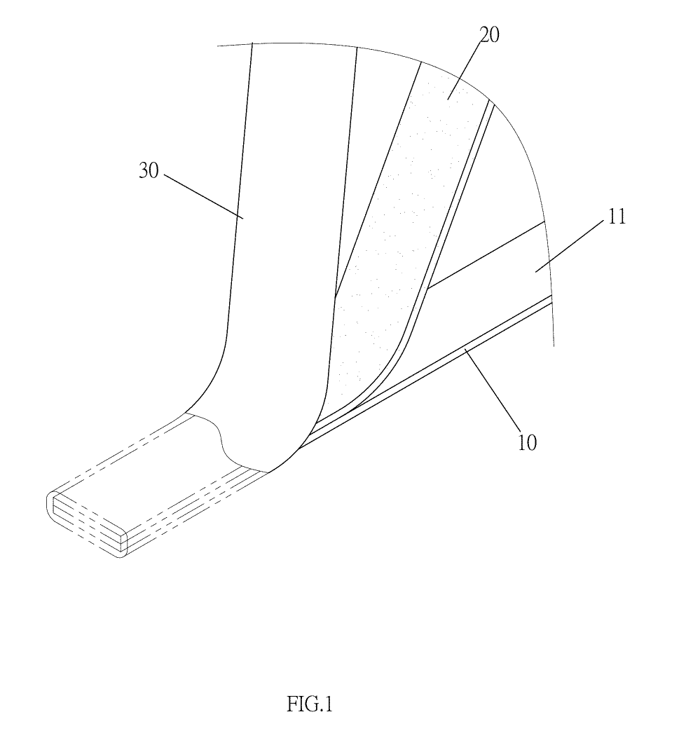

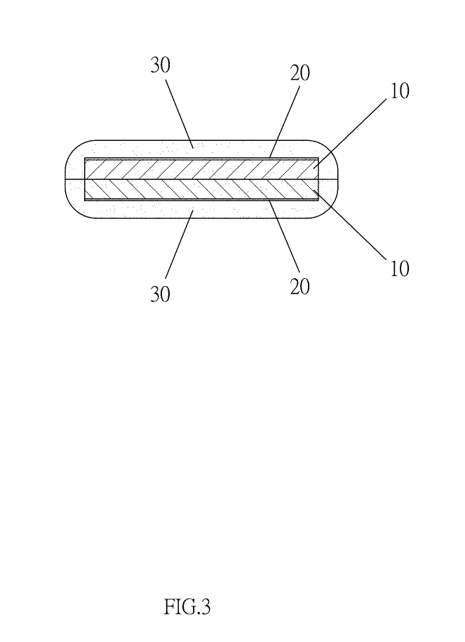

Referring to FIGS. 1 to 5, the waterproof decorative strip according to the present invention mainly comprises a strip body 10, a film layer 20, and a TPU (thermoplastic polyurethane) waterproof layer 30.

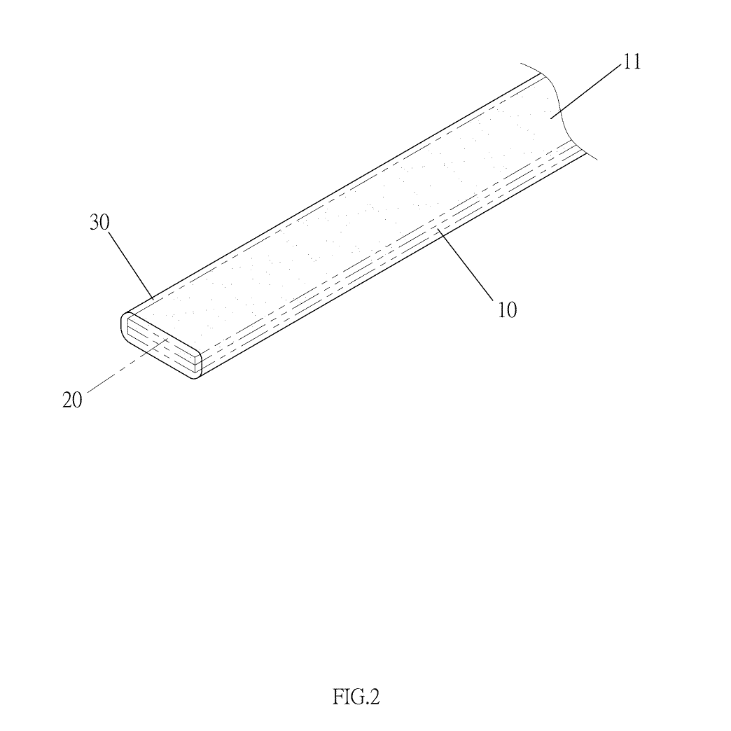

The strip body 10 may be made of leather, synthetic leather, webbing, petrochemical material or the like, and has at least one decorative surface 11. As shown in FIGS. 2, 4, and 5, the decorative surface 11 has different patterns, colors, lines, etc., so that the strip body 10 has a beautifying effect.

Referring to FIGS. 1 to 5, the film layer 20 is assembled on the decorative surface 11 of the strip body 10. The film layer 20 may be made of a material that is adhesive and attached to the strip body 10. Alternatively, the film layer 20 may be made of a material that is nonadhesive and able to cover the strip body 10. In addition, the film layer 20 may be disposed only on the decorative surface 11 or completely cover both sides of the strip body 10. The film layer 20 may be a multi-layer film, a luminous film, a plating film or a color changing film. The film layer 20 can increase the esthetic effect of the strip body 10 and enhance its function.

Referring to FIGS. 1 to 5, the TPU waterproof layer 30 is disposed on an outer side of the film layer 20 for covering the film layer 20 and the strip body 10 to become a whole. Wherein, the TPU waterproof layer 30 covers the film layer 20 and the strip body 10 by laminating or thermo-compression bonding. Similarly, the TPU waterproof layer 30 may cover a single side (with less material), or the TPU waterproof layer 30 may cover both sides (with better water resistance and abrasion resistance), thereby forming the waterproof decorative strip.

Through the above structure, the user may further process the waterproof decorative strip of the present invention. For example, the waterproof decorative strip is adhered to the vamp of a shoe, or made into a bag handle, or made into a belt, a backpack strap, etc. The TPU waterproof layer 30 has water resistance and abrasion resistance, therefore, it has a long service life and it is not easy to be contaminated with dust.

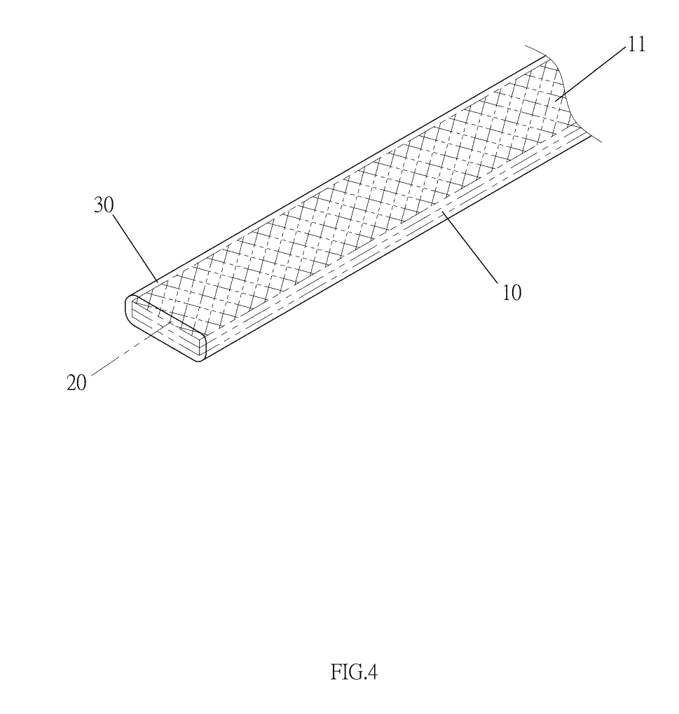

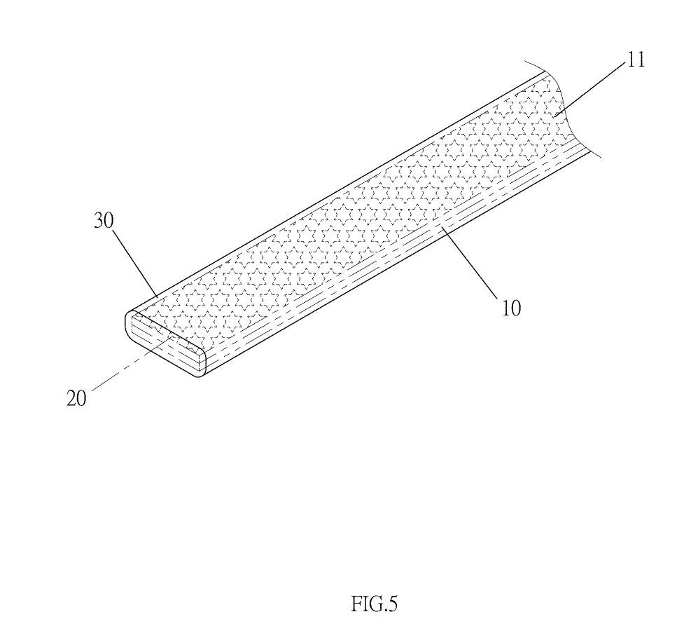

As shown in FIG. 4, the strip body 10 has different lines, which shows better characteristics of the lines when covered with the TPU waterproof layer 30. Alternatively, the strip body 10 itself has no lines and utilizes the film layer 20 to bring a visual effect or functionality. For example, as shown in FIG. 5, the film layer 20 uses a luminous film or the like, so that the waterproof decorative strip of the present invention has a bright effect in a dark place.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A waterproof decorative strip, comprising:
a strip body, having at least one decorative surface;
a film layer, assembled on the decorative surface of the strip body; and
a TPU (thermoplastic polyurethane) waterproof layer, disposed on an outer side of the film layer for covering the film layer and the strip body to become a whole.

2. The waterproof decorative strip as claimed in claim 1, wherein the film layer is selectively made of a multi-layer film.

3. The waterproof decorative strip as claimed in claim 1, wherein the film layer is selectively made of a luminous film.

4. The waterproof decorative strip as claimed in claim 1, wherein the film layer is selectively made of a plating film.

5. The waterproof decorative strip as claimed in claim 1, wherein the film layer is selectively made of a color changing film.

6. The waterproof decorative strip as claimed in claim 1, wherein the film layer is adhesive and selectively attached to the decorative surface of the strip body.

7. The waterproof decorative strip as claimed in claim 1, wherein the film layer is nonadhesive and selectively covers the decorative surface of the strip body.

8. The waterproof decorative strip as claimed in claim 1, wherein the film layer covers two sides of the strip body.

9. The waterproof decorative strip as claimed in claim 1, wherein the TPU waterproof layer covers the film layer and the strip body by thermo-compression bonding.

10. The waterproof decorative strip as claimed in claim 1, wherein the TPU waterproof layer covers the film layer and the strip body by laminating.
